(19) United States
(12) Patent Application Publication
(10) Pub. No.: US 2018/0235834 A1
(43) Pub. Date: Aug. 23, 2018

(54) LEG-PRESSURIZING DEVICE ATTACHABLE/DETACHABLE TO/FROM RIDING APPARATUS

(71) Applicant: Jeongyop RYU, Goyang-si, Gyeonggi-do (KR)

(72) Inventor: Jeongyop RYU, Goyang-si, Gyeonggi-do (KR)

(21) Appl. No.: 15/757,966

(22) PCT Filed: Oct. 4, 2016
(86) PCT No.: PCT/KR2016/011087

§ 371 Date: Mar. 6, 2018

(30) Foreign Application Priority Data
Oct. 6, 2015 (KR) 10-2015-0140053

(51) Int. Cl. A61H 15/00; A63B 22/06

(52) U.S. Cl. CPC A61H 15/00; A63B 22/0605; A61H 2015/0021; A61H 2201/1269; A63B 2213/00; A61H 2201/1671; A61H 2201/1695; A61H 2205/106; A61H 2201/164

(57) ABSTRACT

The present invention relates to a leg-pressurizing device attachable to and detachable from a riding apparatus of the present invention, when a user is pedaling while sitting on a saddle, a pair of calf pressing rollers constantly pressurize lower surfaces of user's calves upward and downward and forward and backward while the user's calves move upward and downward and forward and backward, and a pair of tiptoe pressing rollers constantly pressurize user's tiptoes while the user's tiptoes are rotating, so that the user's calves and tiptoes are pressurized regularly by the rotational movement of the rollers, thereby enabling smooth blood circulation of the leg and preventing various adult diseases.

### TECHNICAL FIELD

The present invention relates to a leg-pressurizing device attachable to and detachable from a riding apparatus, and more particularly, to a device capable of pressurizing calves and tiptoes of a user by pressing members attached to the riding apparatus when the user performs exercise by rotating a pedal coupled to a gear of a bicycle for traveling or bicycle for fitness.

### BACKGROUND ART

A general riding apparatus refers to an apparatus on which a person rides and moves or exercises while riding, and generally includes a bicycle, such as a bicycle for traveling or bicycle for fitness. The riding apparatus is widely used not only as a moving device but also as a fitness device for aerobic exercise and the like. However, the above-mentioned riding apparatus allows a user to perform only aerobic exercise through pedaling, and does not provide other functions, such as blood circulation and fatigue relief by pressurizing a specific part of a leg with a certain pressure from a rotational pedaling motion of the leg.

Accordingly, it is necessary that a new function for physical health be provided in a conventional riding apparatus.

### TECHNICAL PROBLEM

The present invention is directed to providing a leg-pressurizing device attachable to and detachable from a riding apparatus, which is capable of pressurizing a specific part of a user's leg with a certain pressure when a user pedals so that the user's leg rotates and moves upward and downward, in addition to allowing the user to perform aerobic exercise while riding the riding apparatus.

### TECHNICAL SOLUTION

One aspect of the present invention provides the leg-pressurizing device attachable to and detachable from a riding apparatus, the device including a pair of calf pressing rollers and a pair of tiptoe pressing rollers, and when the user is pedaling, the pair of calf pressing rollers constantly pressurize lower surfaces of a user's calves upward and downward while the user's calves move upward, downward, forward, and backward, and the pair of tiptoe pressing rollers constantly pressurize user's tiptoes while the user's tiptoes are rotating.

Another aspect of the present invention provides the leg-pressurizing device including a pair of calf pressing rollers and a pair of tiptoe pressing rollers on a general fitness bicycle, and the leg-pressurizing device applies a certain pressure to a user's leg while the user is pedaling, and the general fitness bicycle includes a frame having a saddle provided at an upper portion thereof, a main gear coupled at a lower portion thereof, and a handle coupled to one side of the frame, and pedals configured to rotate the main gear via pedaling by a user.

### ADVANTAGEOUS EFFECTS

According to the leg-pressurizing device attachable to and detachable from a riding apparatus of the present invention, when the user is pedaling while sitting on the saddle, the pair of calf pressing rollers constantly pressurize lower surfaces of user's calves while the user's calves move upward, downward, forward, and backward, and the pair of tiptoe pressing rollers constantly pressurize user's tiptoes while the user's tiptoes are rotating, so that the user's calves and tiptoes are pressurized regularly by the rotational movement of the rollers, thereby enabling smooth blood circulation of the leg and preventing various adult diseases.

### DESCRIPTION OF DRAWINGS

FIG. 1 is a front view schematically showing a leg-pressurizing device attachable to and detachable from a riding apparatus according to a first embodiment of the present invention.

FIG. 2 is a perspective view showing the leg-pressurizing device attachable to and detachable from a riding apparatus of FIG. 1.

FIG. 3 is a schematic view showing calf pressing rollers of the leg-pressurizing device attachable to and detachable from a riding apparatus according to the first embodiment of the present invention.

FIG. 4 is a schematic view showing tiptoe pressing rollers of the leg-pressurizing device attachable to and detachable from a riding apparatus according to the first embodiment of the present invention.

### MODES OF THE INVENTION

Hereinafter, exemplary embodiments of the present invention will be described with reference to the accompanying diagrams to which detailed descriptions are attached. However, the present invention is not limited to specific embodiments.

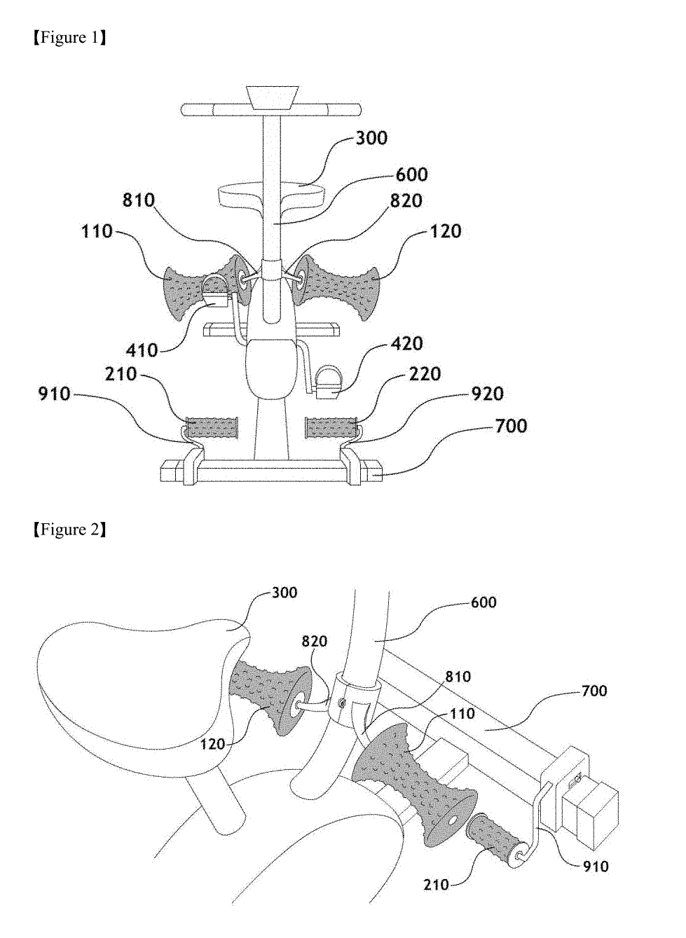

Referring to FIGS. 1 and 2, a leg-pressurizing device attachable to and detachable from a riding apparatus of the present invention is an apparatus in which a leg-pressurizing device is coupled to a general fitness bicycle. Thus, a detailed description of the structure of the bicycle will be omitted, and a leg-pressurizing device coupled to the bicycle will be described in detail.

First, the general fitness bicycle includes a frame 600 having a saddle 300 provided at an upper portion thereof and a main gear coupled at a lower portion thereof, a handle coupled to one side of the frame 600, and pedals 410 and 420 configured to rotate the main gear via pedaling by a user.

The leg-pressurizing device includes a pair of calf pressing rollers 110 and 120 and a pair of tiptoe pressing rollers 210 and 220.

The pair of calf pressing rollers 110 and 120 are fixed by a pair of first elastic links 810 and 820 to the frame 600 disposed vertically on an upper portion of the fitness bicycle, and thus, when a user is pedaling, the user's calves are moving forward, backward, upward, and downward, and the rollers pressurize lower surfaces of the user's calves while rotating by themselves. The first elastic links 810 and 820 are made of an elastic material that can elastically pressurize the calves.

The pair of tiptoe pressing rollers 210 and 220 are fixed by a pair of second elastic links 910 and 920 to a horizontal frame 700 disposed at a lower portion of the fitness bicycle, and thus, when the user is pedaling, the user's tiptoes are rotating, and the rollers pressurize lower surfaces of the user's tiptoes while rotating by themselves each time the tiptoes contact the rollers. The second elastic links 910 and 920 are made of an elastic material that can elastically pressurize the tiptoes.

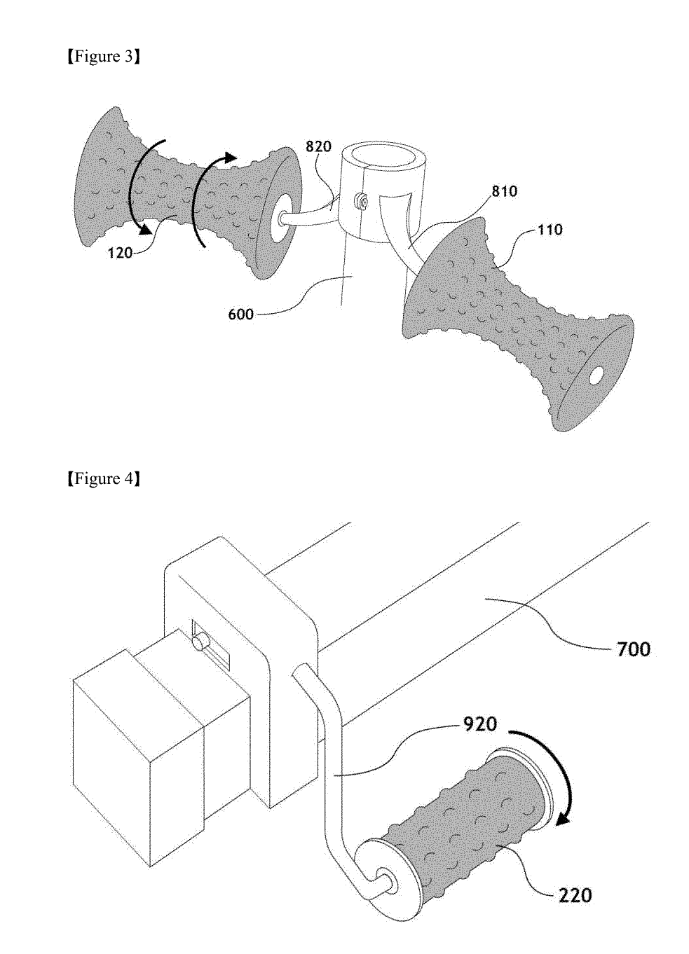

FIG. 3 is a schematic view showing calf pressing rollers of the leg-pressurizing device attachable to and detachable from a riding apparatus according to a first embodiment of the present invention.

FIG. 4 is a schematic view showing tiptoe pressing rollers of the leg-pressurizing device attachable to and detachable from a riding apparatus according to the first embodiment of the present invention.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

### INDUSTRIAL APPLICABILITY

The present invention relates to a device capable of, when a user performs exercise by rotating a pedal coupled to a gear of a bicycle for traveling or bicycle for fitness, pressurizing user's calves and tiptoes by using pressing members attached to a riding apparatus, and has industrial applicability.

1. A leg-pressurizing device for a fitness bicycle including a frame (600) having a saddle (300) provided at an upper portion thereof and a main gear coupled at a lower portion thereof, a handle coupled to one side of the frame (600), and pedals (410, 420) configured to rotate the main gear via pedaling by a user,
the leg-pressurizing device comprising pair of calf pressing rollers (110, 120) and a pair of tiptoe pressing rollers (210, 220) and applying a certain pressure to a user's leg by using the calf pressing rollers (110, 120) and the tiptoe pressing rollers (210, 220) while the user is pedaling.

2. The leg-pressurizing device of claim 1, wherein the pair of calf pressing rollers (110, 120), which are made of an elastic material capable of elastically pressurizing the calves, are fixed by a pair of first elastic links (810, 820) to the frame (600) disposed vertically on an upper portion of the fitness bicycle.

3. The leg-pressurizing device of claim 1, wherein the pair of tiptoe pressing rollers (210, 220), which are made of an elastic material capable of elastically pressurizing the tiptoes, are fixed by a pair of second elastic links (910, 920) to a horizontal frame (700) disposed at a lower portion of the fitness bicycle.
